(19) United States
(12) Patent Application Publication
(10) Pub. No.: US 2024/0384476 A1
(43) Pub. Date: Nov. 21, 2024

(54) FIBER-BASED PACKAGING CAPSULE AND A METHOD OF PRESS-FORMING THE SAME

(71) Applicant: Blue Ocean Closures AB, Karlstad (SE)

(72) Inventor: Lars Sandberg, Hammarö (SE)

(73) Assignee: Blue Ocean Closures AB, Karlstad (SE)

(21) Appl. No.: 18/695,874

(22) PCT Filed: Sep. 22, 2022
(86) PCT No.: PCT/SE2022/050856

§ 371 Date: Mar. 27, 2024

(30) Foreign Application Priority Data
Sep. 27, 2021 (SE) 2151179-5

(51) Int. Cl. D21J 5/00; B27N 5/02; B29C 33/40

(52) U.S. Cl. CPC D21J 5/00; B27N 5/02; B29C 33/40

(57) ABSTRACT

A fiber capsule and a method of compression molding a fiber-based packaging capsule, includes the steps: forming a raw capsule of a loosely bonded fiber mat, which capsule has an opening, positioning the raw capsule of the loosely bonded fiber mat on the inside of a substantially rigid mol having inner surfaces defining the molded outer surfaces of the fiber-based packaging capsule, compression molding the loosely bonded fiber mat by the insertion of a pressurizable compression member through the opening, and pressurizing the pressing device at a temperature of 150-250 degrees C.°, preferably 160-200 degrees C., and at a pressure of 100-5000 bar, preferably 300-1200 bar. The compression molding may take place by reshaping the reshaping pressing device and pressing the inside of the capsule against the inner surfaces of the rigid mold so that a cohesive fiber-based packaging capsule is obtained.

### TECHNICAL FIELD

The present invention relates to a method of forming a fiber-based packaging capsule as well as to a fiber-based packaging capsule.

### TECHNICAL BACKGROUND

A fiber product may be manufactured by press forming a mat or sheet of fibers. Typically a combination of natural fibers (such as pulp fibers from wood), synthetic fibers (such as polyolefin based fibers) and other additives such as binder or color.

Typical process conditions are 150-250 C and pressure 100-10000 bar (200-2000 Bar). Moisture content typically less than 20% water. The fiber product may be a hollow product such as a package or a closure. Products can be formed from a web of the material and punched/cut during forming. Typically, for example, a round is cut to form a round package.

The forming is typically done with two tools where both the outer tool, the pad, and the inner tool, the punch, may consist of several parts to allow for the ejection of the finished product. Typically, the pad is opened while the punch is collapsed. The punch, parts of the punch or parts of the pad may also be made of a compressible material, which allows the tool material to be reshaped during compression.

A capsule may be formed by lining a mold partially or completely internally with a loosely bonded fibrous material. The fibrous material may be draped into the mold or fed into the mold in a form, for example rolled like a cylinder. The mold may be closed or partially open when the material is introduced. Examples of known methods described above are shown in EP 3 736 099 and WO 2020/165780.

However, known methods exhibit certain disadvantages, among others in that the tools are rather complex and therefore expensive.

### BRIEF DESCRIPTION OF THE INVENTION

The present invention relates to a novel method of forming a fiber-based packaging capsule which at least partially solves problems of existing methods, as defined in claim 1 or a fiber-based packaging capsule as claimed in the patent.

Thanks to the invention, relatively simple tools can be used to form a fiber-based packaging capsule, enabling high quality and cost-effective manufacturing.

Many advantages can be achieved by introducing an elastic moldable material into a cavity formed by a raw capsule. The material is preferably an elastic polymer or a rubber material. The moldable material is then pressed into the mold with such force that it is subjected to a high pressure of several or tens of hundreds of bars. The mold and/or the material preferably has a temperature of 150-250 degrees. The fiber material preferably has a moisture content of between 3 and 20%. Preferably, a holding time of 0.10-5 s is used to transform the loosely cohesive raw capsule into a well-composed, rigid fiber capsule, the fiber material of which preferably has a density of between 0.5-1.5 g/cm2.

### FIGURE DESCRIPTION

In the following, the invention will be described with reference to a preferred specific embodiment of a method according to the invention by schematically, stepwise describing the manufacture of the specific preferred embodiment, wherein:

FIG. 1 shows a raw capsule,

FIG. 2 shows the crude capsule filled with a plurality of reformable pressure distributing members and a pressurizing member partially inserted through the opening of the capsule,

FIG. 3 shows the raw capsule positioned inside an expanded rigid mold,

FIG. 4 shows that the rigid mold has been closed and that pressurisation has taken place by means of the pressurising part,

FIG. 5 shows a fully formed fiber capsule, the pressurising part extracted and the pressure distributing part remaining inside the fiber capsule,

FIG. 6 shows that the pressure-distributing elements are removed from the fiber capsule by gravity.

### DETAILED DESCRIPTION

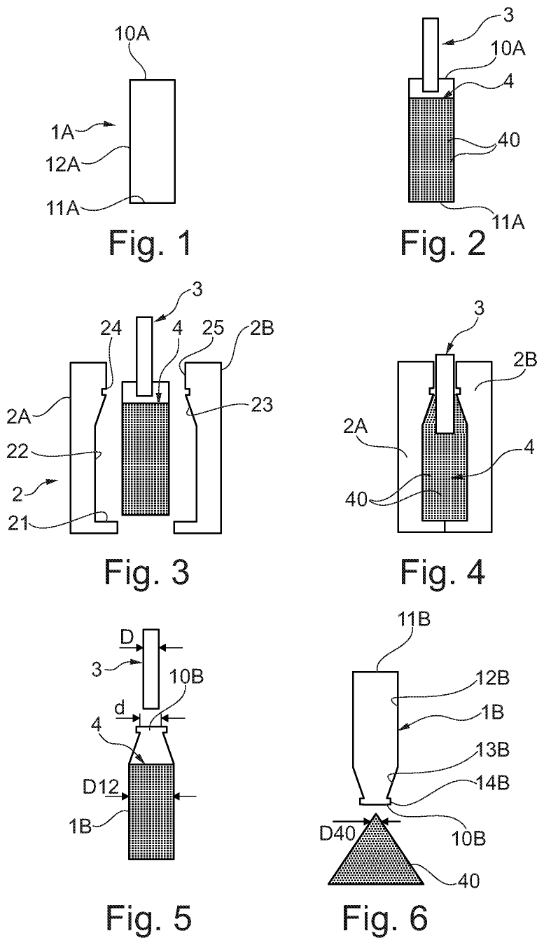

FIGS. 1-6 show a preferred special embodiment for the use of the method according to the invention, namely a special embodiment where the opening 10B of the desired fiber capsule is too small to be able to insert a coherent re-shapable pressing member of the required size, meaning that the elastic material of such a coherent re-shapable pressing member cannot fill and pressurize with sufficient pressure the entire cavity which needs to be pressurized during the compression molding operation.

FIGS. 1-6 schematically show that the above problems can be easily solved by a method according to the invention, wherein a raw capsule 1A is fed through its opening 10A with a plurality of, smaller sized, re-shapable partial bodies 40 of elastic material, preferably in the form of granules, before the forming tool 2 is pressed together and pressurized. After the forming operation and after the packaging capsule 1B has been removed from the forming tool 2, these granules can be emptied or otherwise fed out of the formed capsule via the opening 10B. The forming of the above special case then comprises essentially six steps:

1. A loosely bonded fibrous material is preformed into a cylinder or the like, preferably so as to form a crude capsule 1A having a bottom 11A, cylindrical side walls 12A and an opening 10A, see FIG. 1.

2. The raw capsule 1A is partially or completely filled with granules 40 (which may occur before or after the forming tool 2 is closed), which form a pressure distribution part 4, see FIG. 2. These granules 40 are then advantageously heated to 150-250 degrees. The surface of the granules is advantageously designed so that they do not stick together under pressure, for example by a coating.

3. The mold 2 is closed, see FIGS. 3 and 4. It is then advantageously heated to 150-250 degrees.

4. The forming tool 2 is pressurised by a pressurising part 3 being lowered into the closed forming tool 2 and then displacing air and granules 40 so that they are later reshaped and will form a substantially solid pressurised volume, see FIG. 4. The pressurizing part 3 may advantageously, but need not, be made of an elastically deformable material and thereby pressurize the upper part of the capsule walls and/or opening. In this way, protruding parts 14B can be formed at the top, for example collars and/or threads can be formed. The forming tool 2 preferably comprises at least two dismountable parts 2A, 2B and together forms a bottom 21, side walls 22, 23 (wherein first side walls 22 and second side walls 23 (or more) preferably have different shapes) and an opening 25.

5. The pressure is relieved on the forming tool 2 by relieving the pressure applying part 3 and passing it out through the opening 10B of the formed packaging capsule 1B, see FIG. 5. The granules 40 in the packaging capsule 1B then return to their previous shape or a shape similar to the previous shape.

6. The granules 40 are removed from the packaging capsule 1B, preferably by turning it upside down, see FIG. 6. It is understood that the granules 40 may be expelled by other means, for example by suction under negative pressure. Preferably, the discharge can be combined/supported by shaking and/or vibration.

According to a more general principle of the invention, the method comprising the steps:
a raw capsule 1A of a loosely coherent fibrous mat is formed, which capsule has an opening 10A,
the raw capsule 1A of the loosely cohered fiber mat is positioned on the inside of a substantially rigid forming tool 2 having inner surfaces 21, 22, 23, 24 which define the compression molded outer surfaces of the fiber-based packaging capsule,
the loosely bonded fibrous mat is compression molded by pressurizing a pressure-reformable pressing member 3, 4 through said opening 10A,
said presser 3, 4 is pressurized at a temperature of 150-250 degrees C.°, preferably 160-200 degrees C., and at a pressure of 100-5000 bar, preferably 300-1200 bar, whereby compression molding is performed by reshaping the reshaping presser 3, 4 and pressing the inside of the capsule 1 against the inner surfaces 20, 21, 22, 23 of the rigid mold so as to obtain a cohesive fiber-based packaging capsule 1B.

It will be appreciated that the basic concept of the invention is not limited to the manufacture of packaging capsules 1B according to the preferred example shown above, but that many variations may be present, such as, for example, that the method may also be used to manufacture packaging capsules 1B with a larger opening 10B than the maximum width dimension D12 of the side surfaces 12B.

Preferably, said crimping device 3,4 comprises a plurality of unassembled parts including a first substantially pressurizing part 3 and a second substantially pressure distributing part 4, wherein at least said second part 4 is at least partially reformable, wherein more preferably said second part 4 includes a plurality of part members 40 free from each other and free from said first part 3 reformable, which are preferably reused in at least one further forming operation.

Preferably, the re-shapable partial members 40 are in the size range of 1-20 mm and preferably with surfaces which do not stick together, for example by means of a surface coating. Preferably, the re-shapable partial members 40 are made of a synthetic or natural polymer and/or of rubber, preferably with a hardness in the range of 10-100 Shore A. Preferably, the re-shapable partial members 40 have a maximum width dimension D40 which is smaller than the minimum width dimension d of said opening 10 of said packaging capsule 1B, preferably at least 50% smaller, more preferably at least 20% smaller, most preferably at least 10% smaller.

As shown in FIG. 1-6, said opening 10B can advantageously have a maximum width dimension d substantially smaller than the maximum width dimension D12 of the packaging capsule 1B, meaning that, a sealable opening 10B can be provided which has substantially smaller maximum width dimension d than the maximum width dimension D12, whereby, a sealable opening 10B can be provided which has a substantially smaller maximum width dimension d than the maximum width dimension D12 of the packaging capsule, which is a great advantage, and this without having to use particularly complex tools. Thanks to the invention, it is relatively easy to produce high-quality fiber capsules with very varied shapes and with an internal surface exhibiting a plurality of re-shapable partial bodies 40 molded partial surfaces.

1. A method of compression molding a fiber-based packaging capsule, comprising the steps of:
forming a raw capsule of a loosely bonded fibrous mat, which raw capsule has a moisture content between 3% and 20% and an opening,
positioning the raw capsule of the loosely bonded fibrous mat on the inside of a substantially rigid mold having inner surfaces defining the compression-moulded outer surfaces of the fiber-based packaging capsule,
compression molding the loosely bonded fibrous mat by inserting a pressure-reformable pressing member through said opening, the pressing member being formed of a plurality of unassembled parts including a first substantially pressure-applying part and a second substantially pressure-distributing part, at least said second part being at least partially reformable,
pressurizing said pressing member at a temperature of 150-250 degrees C.°, and at a pressure of 100-5000 bar, wherein press forming takes place by reshaping the re-shapable pressing member and pressing the inside of the capsule against the inner surfaces of the rigid mold so that a solid cohesive fiber-based packaging capsule is obtained.

2. Method according to claim 1, wherein said second part comprises a plurality of mutually free reformable partial members and free from said first part, wherein preferably said reformable partial members are reused in at least one further forming operation.

3. Method according to claim 2, wherein said re-shapable partial members are in the size range of 0.5-20 mm.

4. Method according to claim 2, wherein said re-shapable partial members are made of a synthetic or natural polymer and/or of rubber.

5. Method according to claim 2, wherein said re-shapable partial members (40) are arranged with non-sticking surfaces.

6. Method according to claim 1, wherein said re-shapable partial members have a maximum width dimension (D) which is smaller than the minimum width dimension (d) of said opening of said packaging capsule.

7. Method according to claim 6, wherein said re-shapable partial member is at least partially pushed out through said opening of the packaging capsule by means of gravity.

8. Method according to claim 1, wherein said opening has a maximum width dimension (d) which is smaller than the maximum width dimension (D12) of the packaging capsule.

9. Method according to claim 8, wherein said opening has a maximum width dimension (d) less than half of the maximum width dimension (D12) of the packaging capsule.

10. Method according to claim 1, wherein said method is formed of a loosely coherent fibrous mat comprising predominantly natural fibers.

11. Method according to claim 1, wherein said raw capsule is formed from a fibrous mat comprising predominantly natural fibres from trees.

12. Method according to claim 11, wherein said raw capsule is formed of a loosely coherent fibrous mat containing a binder.

13. A fiber capsule, wherein the fiber capsule comprises an inner surface that exhibits a plurality of molded partial surfaces formed by reshapable partial organs.

14. A fiber capsule produced by a method according to claim 1, wherein the opening of the fiber capsule has a maximum width dimension (d) which is smaller than the maximum width dimension of the packaging capsule, said opening preferably having a maximum width dimension (d) which is less than half of the maximum width dimension of the packaging capsule.

15. A fiber capsule produced by a method according to claim 1, wherein the area at the opening of the fiber capsule there is at least one radially outwardly projecting part.
